(19) United States
(12) Patent Application Publication
(10) Pub. No.: US 2015/0338238 A1
(43) Pub. Date: Nov. 26, 2015

(54) ELECTRICAL DEVICE INSTALLATION IMPROVEMENT

(71) Applicant: EMBERTEC PTY LTD, Dulwich, South Australia (AU)

(72) Inventor: Domenico Gelonese, Dulwich (AU)

(73) Assignee: Embertec PTY LTD, Dulwich, South Australia (AU)

(21) Appl. No.: 14/654,134

(22) PCT Filed: Mar. 8, 2013
(86) PCT No.: PCT/AU2013/000235

§ 371 Date: Jun. 19, 2015

(30) Foreign Application Priority Data
Dec. 20, 2012 (AU) 2012268776

(51) Int. Cl. G01D 4/00; G06Q 30/02

(52) U.S. Cl. CPC G01D 4/002; G06Q 30/0207

(57) ABSTRACT

An electrical device is described that is adapted to be installed by connection to a mains electricity supply, the electrical device including communication means adapted to communicate to a monitoring entity, such as an energy company or similar, when the electrical device is installed.

### FIELD OF THE INVENTION

The present invention relates to an apparatus and method for the verification of installation of electrical equipment, in particular verification acceptable to a party not being an installer or end user of the electrical equipment. This may include verification of ongoing use, including the amount of such use.

### BACKGROUND

When a user installable electrical device is installed typically the device is plugged into a suitable outlet that is connected to the mains electrical supply. This may be a wall outlet, sometimes referred to as a general purpose outlet (GPO), but can also be a power extension board or similar. In the case of a light fitting, it may also be a light socket directly wired to mains electrical supply. Verification of the installation, if required, requires no more than the observation, by the installer, that the most basic functions of the device are operational.

There is currently world-wide concern about the level of use of electrical energy for both domestic and commercial uses. In part this concern is based on the greenhouse gas production associated with the generation of the electrical energy, and the contribution of that greenhouse gas to anthropomorphic global warming. There is also a concern for the capital cost involved in building the electricity generating plants and electricity distribution networks required to generate and distribute an increasing amount of electricity.

One method which is employed to reduce energy consumption, or at least to slow growth in the level of energy consumption, has been the introduction of more efficient electrical device and appliances. Such devices are in many cases significantly more expensive to buy than equivalent or alternative devices which have higher energy consumption. This higher initial cost is a significant barrier to the replacement of electrical device with electrical devices having lower energy consumption. This is often the case, even when electricity costs are such that, over the life of the electrical device, the saving in running costs outweighs the additional initial cost.

In order to encourage installation of reduced energy consumption devices, energy saving incentives may be provided by such entities as energy retailers, electricity distributors, electricity generators and government bodies. Incentives, which may be direct payments, free or subsidised supply of the devices, reductions in electricity bills or any other acceptable incentive, are provided by the entity to a consumer or end user in an attempt to encourage the consumer, be they domestic or commercial, to acquire such devices and to install the devices in a manner such that a reduction in energy use by the consumer is likely to occur. The entities wish only to provide the incentives in cases where the devices are installed appropriately, and may also wish to be assured that the devices continue to be used over a period of time.

A shortcoming in such incentive schemes is that the entity providing the incentive has great difficulty in verifying that the lower energy consumption electrical devices have been installed in the domestic or commercial premises. If the lower energy consumption device is installed by a qualified installer there is a greater level of confidence that the device is installed correctly so long as the installer is competent and trustworthy. Achieving this level of confidence requires that the installer does not engage in fraudulent behaviour, which requires significant resources to independently verify.

If the lower energy consumption device is installed by the consumer or end user, then there is comparatively less confidence that that the device has been installed correctly, or indeed at all. All that can be known with certainty is that the lower energy consumption device has been purchased by or supplied to the consumer.

Such incentive schemes are open to exploitation as the present best way available to positively verify correct installation and ensure that the lower energy consumption device is actually installed is undertaking a physical audit of installations. Such audits are expensive and time consuming and therefore it is not viable to audit every installation that has been undertaken. The result is a low level of confidence that the lower energy consumption devices have actually been installed and installed correctly.

A further issue arises in that the third party provides incentives for the installation of low energy consumption devices based on the assumption that the devices will remain installed and continue to provide energy savings. Low energy consumption devices may in some instances cause minor inconvenience when compared to higher energy consumption equivalents, which may be sufficient to motivate the user to uninstall the low energy consumption device.

Further, the amount of any incentive or payment for the installation of low energy consumption device is generally determined based on the expected total energy savings over the lifetime of the device, or some shorter time period. These savings may vary depending upon the usage of the device following installation, thus there is a problem in providing the appropriate incentive for the amount of energy saved by a specific installation.

Throughout this specification, the term “qualified installer” refers to a person or company authorised to install the low energy consumption device. The term “installer” may refer to a qualified installer or to any other party, including an end user, who undertakes an installation of a low energy consumption device.

### SUMMARY OF THE INVENTION

In one form of this invention a there is proposed an electrical device adapted to be installed by connection to a mains electricity supply, the electrical device including communication means adapted to communicate to a monitoring entity when the electrical device is installed.

In order for any effective incentive to be paid for the installation of an appliance of a type which uses less energy than alternative appliances having the same function, which may therefore be called energy saving devices, it is necessary for the person paying the incentive to be reasonably certain that the appliance has in fact been installed.

In preference, the communication to the monitoring entity upon installation includes an installation validation signal

In preference, the installation verification signal includes a verification code.

In preference, the verification code is unique to the particular electrical device being installed.

Validation that an installation has occurred, and optionally that the installation has been of a particular device, allows the person paying the incentive to be reasonably certain that the appliance has in fact been installed.

In preference, the electrical device is further adapted to be plug connected to the mains energy supply.

In preference, the electrical device is further adapted to be plug connected to a fixture adapted to provide electrical energy suitable for the electrical device.

The person paying the incentive may be particularly concerned to establish the validity of an installation which may be performed by an end user or an unskilled or low skilled qualified installer.

In preference, the electrical device is a low energy consumption device.

In preference, the electrical device is a luminaire.

In preference, the luminaire is an LED luminaire.

In preference, the luminaire is a compact fluorescent light luminaire.

Lighting is an area where there is considerable scope for energy saving by use of lower energy consumption devices

In preference, the communication means is a wireless communication module.

In preference, the communication means includes one or more of a Wi-Fi communication module; a power line communication module and a Zigbee communication module.

Communication of the installation verification may be performed economically using either wireless means or the existing or essential electrical wiring for the device.

In preference, the communication means is further adapted to communicate information concerning the ongoing use of the electrical device to a monitoring entity.

A person paying an incentive for a low energy consumption device to be installed may wish to relate the amount or timing of the provision of the incentive to the amount of energy actually saved by the particular low energy device installation.

In a further form the invention may be said to lie in a method for verifying the installation of an electrical device by which a third party, not being an installer or an end user of the electrical device, may have a higher degree of confidence that said installation has occurred, the method including the step of:

the electrical device, upon installation, communicating verifying information, sufficient to verify that the installation has occurred, to the third party.

In preference, the method includes the third party determining that the verifying information is sufficient to verify that the electrical device has been satisfactorily installed.

In preference, the third party, upon determining that the verification code is valid, provides a valuable consideration to the end user of the electrical device as an incentive for installing the electrical device.

In a yet further form the invention may be said to lie in a method for verifying the installation of an electrical device by which a third party, not being an installer or an end user of the electrical device, may have a higher degree of confidence that said installation has occurred, the method including the steps of:

the electrical device, upon installation, establishing communications with a local intermediary device,
the electrical device, upon installation, transmitting a verification code able to identify the electrical device to the local intermediary device,
the local intermediary device communicating the verification code to the third party.

In preference, the method further includes the steps of

the third party determining that the verification code is valid and, upon determining that the verification code is valid, providing a valuable consideration to the end user of the electrical device as an incentive for installing the electrical device.

In a further form the invention may be said to lie in a In a further form the invention may be said to lie in a method for providing an incentive for the installation and continuing use of a low energy consumption electrical device including the steps of the electrical device, upon installation, communicating verifying information, sufficient to verify that the installation has occurred, to a third party not being an installer or an end user of the electrical device;

the third party determining that the verifying information is sufficient to verify that the electrical device has been satisfactorily installed;
the electrical device communicating usage information to the third party about the ongoing use of the electrical device;
the third using the usage information to determine a degree to which the installation and continuing use of the electrical device is contributing to reduced energy consumption;
the third party providing on one or more occasions, a valuable consideration to the end user of the electrical device.

### BRIEF DESCRIPTION OF THE DRAWINGS

By way of example, an embodiment of the invention is described more fully hereinafter with reference to the accompanying drawings, in which:

FIG. 1 is an illustration of an LED lighting fixture incorporating the invention;

FIG. 2 is a cross-section view of the luminaire of the fixture of FIG. 1;

FIG. 3 is a diagrammatic representation of a lighting fixture in accordance with the invention;

FIG. 4 is a diagrammatic representation of an installation including a lighting fixture in accordance with the invention;

FIG. 5 is a diagrammatic representation of a further installation including a lighting fixture in accordance with the invention;

FIG. 6 is a diagrammatic representation of a further installation including a lighting fixture in accordance with the invention;

FIG. 7 is a flow chart showing the method of an embodiment of the present invention wherein there is a qualified installer;

FIG. 8 is a flow chart showing the method of an embodiment of the present invention wherein the installation is undertaken by an end user;

FIG. 9 is a flow chart showing the method of an embodiment of the present invention wherein the continuing installation and/or amount of continuing use of the device is communicated to a third party.

### DETAILED DESCRIPTION OF THE INVENTION

Lighting is a significant contributor to the energy use of domestic and commercial premises. Most forms of lighting are quite inefficient, in that a large proportion of the energy which the lighting installation consumes is converted to heat, rather than light. This is particularly true of incandescent globes, but is also true of halogen lights, and even of fluorescent tubes.

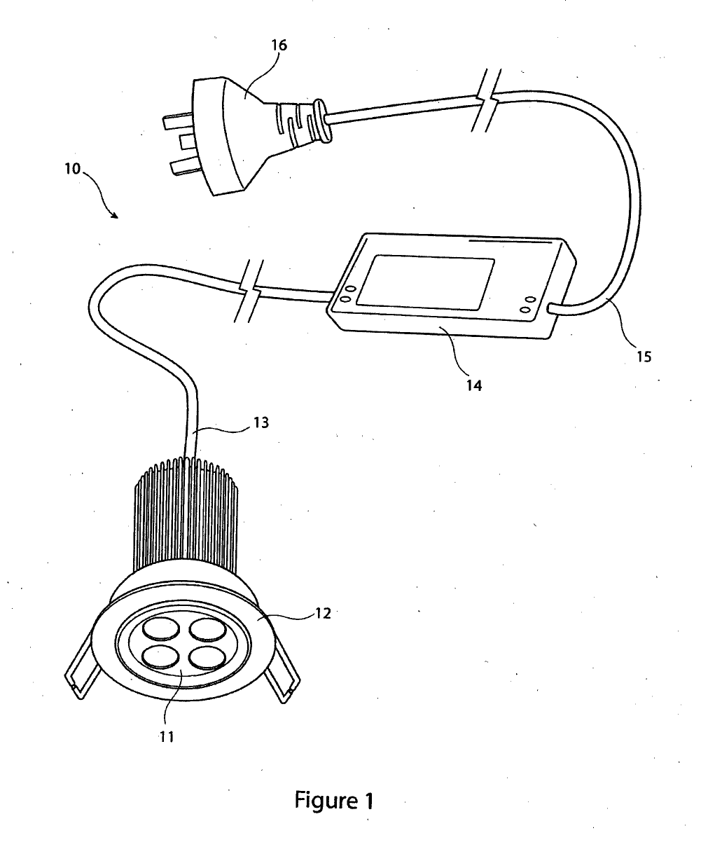

One form of lighting which is particularly energy efficient is the use of LEDs (light emitting diodes) for lighting. Referring to FIG. 1, there is a lighting fixture 10, comprising a luminaire 11 which is held by a housing 12. Power is supplied to the luminaire via cable 13 from transformer 14. The transformer receives electrical energy via high voltage cable 15, which terminates in plug 16 which is adapted to plug into a mains electricity socket. In a further embodiment, not illustrated, the high voltage cable is directly wired to a mains electricity supply.

LED luminaires are often installed as a retrofit in order to reduce energy consumption of the lighting in domestic premises. In this case, it is advantageous to replace as little of the previously existing lighting installation as possible. A lighting technology which is often replaced by LED lighting is halogen lighting. In such a case it is preferable to replace only the halogen globe and to reuse the housing and the transformer. This usually obviates the need to enter ceilings or other difficult to access spaces in order to retrofit the LED Iuminaire. This is the situation illustrated in FIG. 1, where the transformer is a transformer suitable for use with halogen lights. The housing is also suitable for connection of a halogen downlight.

In a further embodiment, not shown, the luminaire is directly powered from the mains electricity supply, whether by plug connection to a holder which is connected to a mains supply, by a pluggable cable or by direct wiring, or by plug connection to a cable which is connected directly or by plug connection to a mains supply. These configurations may be undertaken as a retrofit or as an initial lighting installation.

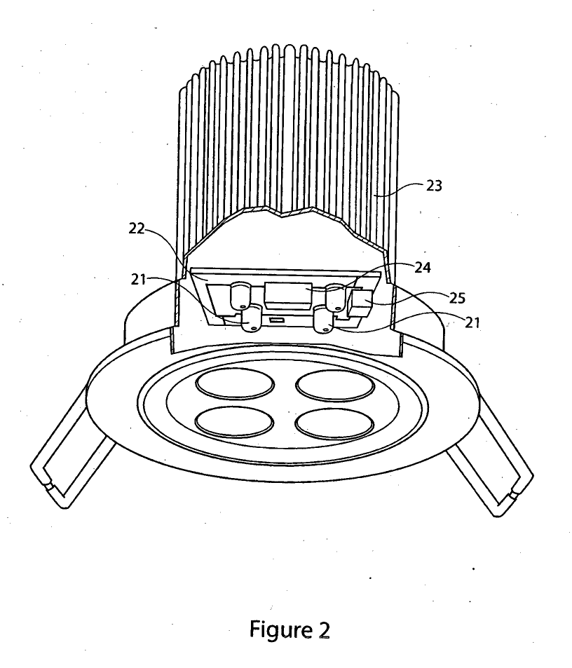

Referring to FIG. 2, which is a cross-section illustration of the luminaire 11, the luminaire includes lighting elements in the form of LEDs 21. These LEDs are controlled by driver module 24 on PCB 22, which ensures that the appropriate voltage is provided to the LEDs. This may also include circuitry to shut down the LEDs to prevent overheating. The luminaire also includes heatsink 23 which dissipates heat from the LEDs. LEDs are sensitive to overheating, which dramatically shortens the working life of an LED. There is also provided a microcontroller 25, which performs processing and communication functions.

LEDs are a relatively new technology in this application, and a number of technical challenges needed to be overcome to make an LED lighting product suitable for general use, and LED luminaires remain technically complex. Consequently, LED luminaires have a very high purchase cost, compared to less energy efficient lighting methods. Although the much greater energy efficiency and long operational life of LED luminaires in general means that LED based lighting has a lower total cost of ownership over the lifetime of a luminaire, the high initial cost is a significant barrier to the widespread installation of LED lighting, particularly in domestic premises.

There are third parties, other than the users or suppliers of energy efficient devices such as LED lighting, who have an interest in the installation of energy efficient devices.

One such third party is Government. Governments may wish to reduce electricity usage, in order to reduce the greenhouse gas emissions associated with electricity production. Governments may also wish to reduce or delay expenditure on electricity generation and distribution infrastructure which are required by increasing energy usage.

Another group of third parties are energy utilities: electricity generators, distributors and retailers. Either through requirements placed upon them by governments having the motives described above, or in order to meet their own requirements for cost reductions, these utilities may wish to reduce electricity consumption.

In other circumstances, the third party might be a building owner who is responsible for the energy consumption of tenants.

Such third parties may be willing to provide incentives for the installation of energy efficient devices in domestic and commercial premises. In particular they may wish to provide an incentive for the retrofitting of energy efficient devices in circumstances where installed, less energy efficient devices have not reached the end of their operational life.

Thus there may be installed low energy consumption devices, being electrical devices which achieve the same or similar outcomes as currently installed devices, while consuming less electrical energy. The low energy consumption electrical devices may be installed in circumstances where a third party other than the installer and the user of the connected electrical devices has an interest in knowing the installation status of the device.

This third party wishes to be certain that a low energy consumption device has been installed prior to providing the incentive.

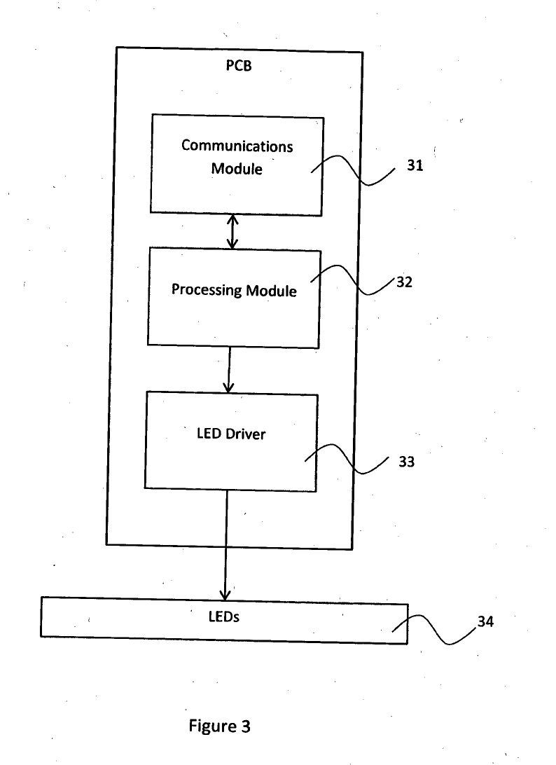

The functional blocks of the circuitry of PCB 22 are shown in FIG. 3. There is a communications module 31. This communications module may use any suitable wired or wireless communications protocol, including without limitation, Zigbee, Wifi, Bluetooth and any form of power line communication.

There is a processing module 32 which controls the communications module 31 and communicates via the communications module. There is a driver module 33 which provides appropriate voltage to drive the LEDs 34 in the luminaire. The processing module may also control the illumination of the LEDs.

A function of the communications module is to communicate to the third party that the low energy consumption device has been installed. In preferred embodiments, this communication is via the installer. This communication is made in such a manner that it is difficult for an installer to report an installation for which the incentive will be made available, when, no such installation has taken place. This ensures that the energy supplier or other third party will only pay the incentive in cases where the low energy consumption device has been installed.

In a preferred embodiment, the communications module communicates a unique verification code to the installer. This verification code is unique to the particular low energy consumption device unit which is installed.

The verification code is transmitted to the installer as data. The communications module includes data transmission capability. The communications module may include a wireless connection capability such as Wi-Fi, which may communicate to a mobile computing device such as a laptop computer or a smartphone carried by the installer.

Other wireless communication methods, including without limitation infra-red (IR), any radio frequency protocol (RF), or Bluetooth, may be used.

Having obtained the verification code indicating an acceptable installation, the installer, who may either be a qualified installer or a domestic or commercial end user, then proceeds to report the verification code to the third party. The third party verifies that the supplied verification code correspond to a valid verification code for a low energy consumption device. Upon such verification, the third party provides whatever incentive it has agreed to supply for a successful installation. This may be direct payment of money to a qualified installer. It may be a rebate on the bill of a domestic or commercial consumer. It may be not billing a domestic or commercial consumer for the cost of the low energy consumption device. It may be reward points in a loyalty program or similar scheme. Any other acceptable incentive may be used.

In an alternative embodiment, the communications module communicates the unique verification code directly to the third party incentive supplier. This may be done by means of an internet connection or by any suitable network connection. The communication may be made directly via the electrical wiring to which the low energy consumption device is connected. The communications module may communicate the verification code to an intermediary device already installed, or installed simultaneously, at the installation location which is able to communicate to the third party which may be an energy supplier. Such a device may be a Smartmeter, being a meter for measuring the electricity consumption of a household or other site, and communicating these measurements to an energy supplier. The intermediary device may be a device such an in home display device, which is designed to communicate with appliances and to provide information about energy consumption. This communication may be by any wired means, including power line communication, or by wireless means such as Wi-Fi, a proprietary RF protocol, Bluetooth or ZigBee, or any other suitable wireless communication method. In this case the third party receives the verification code and checks that it is a valid verification code. Upon verification, the third party provides the promised incentive.

Verification is done by checking the received verification code against a list of valid verification codes supplied by the manufacturer of the low energy consumption device or of the communication module to the third party.

The verification code may include a checksum which helps to ensure that the verification code have not been copied incorrectly in the process.

Other data may be used to assist with verification, such that all data must be consistent to achieve verification. This data may include a serial number applied to the low energy consumption device which has a unique relationship to the verification code for that device. The data may include the identity of the qualified installer, in the case that a pool of low energy consumption devices with a known pool of verification codes is provided to each qualified installer. In such a case, even a valid verification code would not result in verification if provided by someone other than that qualified installer.

The third party may not undertake the verification, but may communicate the verification code to the manufacturer'of the low energy consumption device or of the communications module to allow them to perform the validation.

The party performing the validation keeps records of which verification codes have been presented for validation, to prevent re-use of the verification code by an installer in order to gain an incentive without performing a correct installation.

In a further embodiment, verification takes place without a specific verification code. The occurrence of communication between the low energy consumption device and the intermediary device, and subsequent communication of this to the third party may be sufficient to verify that an installation has taken place, This communication may include information such as unique serial number or a shared group identifier, which allows at least some level of identification of the particular low energy consumption device installed.

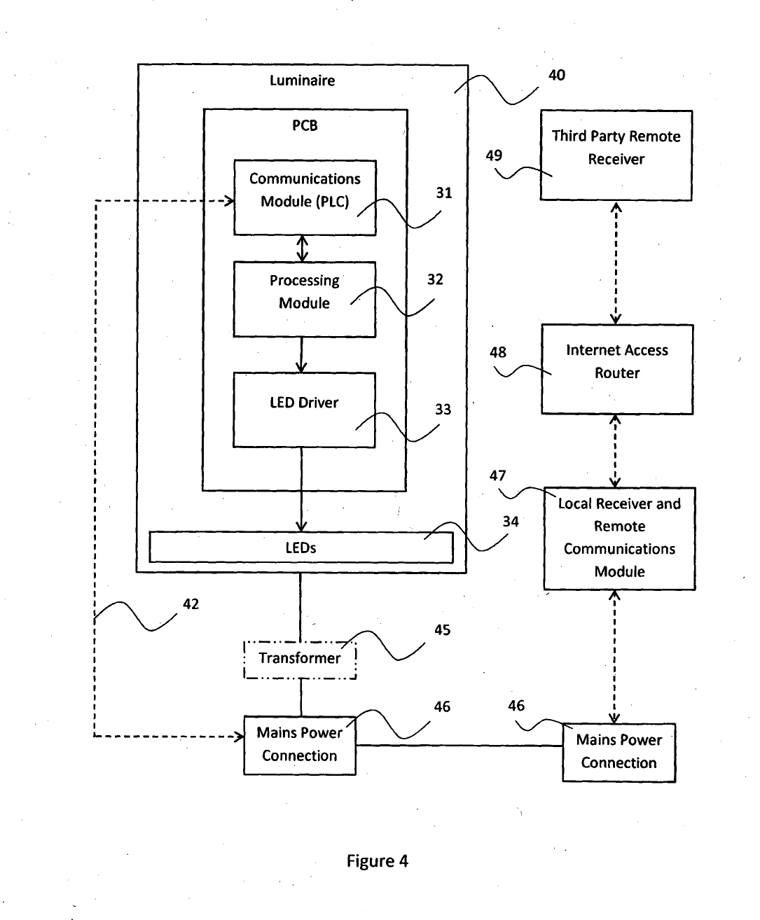

Referring now to FIG. 4, there is illustrated an embodiment of the invention wherein the communication method employed is power line communication (PLC). There is provided a luminaire 40, which includes the elements illustrated in FIG. 3, being the LEDs 34 and the LED driver 33. There is also a processing module 32, which is in direct data communication with the LED driver. The processing module 32 is also in direct communication with a communications module which is adapted for power line communication 41.

Mains electricity is supplied to the luminaire from Mains Power Connection 46, which may be via optional transformer 45. The transformer will often be present in the case where the LED luminaire is retro-fitted into an installation previously employing a low voltage halogen luminaire. In this case it is convenient to leave the transformer in place, since removal of the transformer may require the services of an electrician, which is expensive, and/or entry into roof spaces, which is inconvenient, and may also increase the cost of installation.

The Communications Module 41 provides external communications 42 via power line communication protocol. This allows data communication to be carried over the wiring which provides electrical energy. Power line communication is generally of limited range. In a preferred embodiment, the Communications Module communicates via power line communication to the Local Receiver and Remote Communications Module 47. The Local Receiver and Remote Communications Module 47 is connected to and powered by Mains Power Connection 46. This connection also provides the physical connection for data communications with the Communications Module 41 using power line communications.

The Local Receiver and Remote Communications Module will generally be located in the premises where the low energy consumption device is installed. The Local Receiver and Remote Communications Module is in data communication with an Internet Access Router 48. This Internet Access Router allows the Local Receiver and Remote Communications Module to communicate via the internet to a Third Party Remote Receiver 49.

In use, when the low energy consumption device, in this embodiment the luminaire 40, is connected to mains electricity, the Processing Module 32 indicates the successful installation by communicating a verification code. The verification code is communicated from via the Communications Module 41 to the Local Receiver and Remote Communications Module 47. The Local Receiver and Remote Communications Module may add additional data which is then communicated along with the verification code to the Third Party Remote Receiver, using the internet, via the Internet Access Router. The Third Party Remote Receiver then validates the verification code, and passes the information to the third party or a third party system. The third party, having notice of a successful installation, may then proceed to provide the agreed incentive, or to record a successful installation for reporting purposes.

In an alternative embodiment, the Local Receiver and Remote Communications Module may include an internet access capability, removing the requirement for a separate Internet Access Router.

In an alternative embodiment, the Local Receiver and Remote Communications Module may include a mobile telecommunications data communication capability, also removing the requirement for a separate Internet Access Router.

In an embodiment where power line communication over greater distances is feasible, Internet Access Router 48 and Local Receiver and Communications Module 47 may be absent. In this case the Communications Module 41 communicates directly with the Third Party Remote Receiver 49.

In an alternative embodiment, the Local Receiver and Remote Communications Module may be equipped to determine that the verification code is valid or sufficient. In this case, only the fact that a successfully verified installation has occurred may be communicated to the Third Party Remote Receiver.

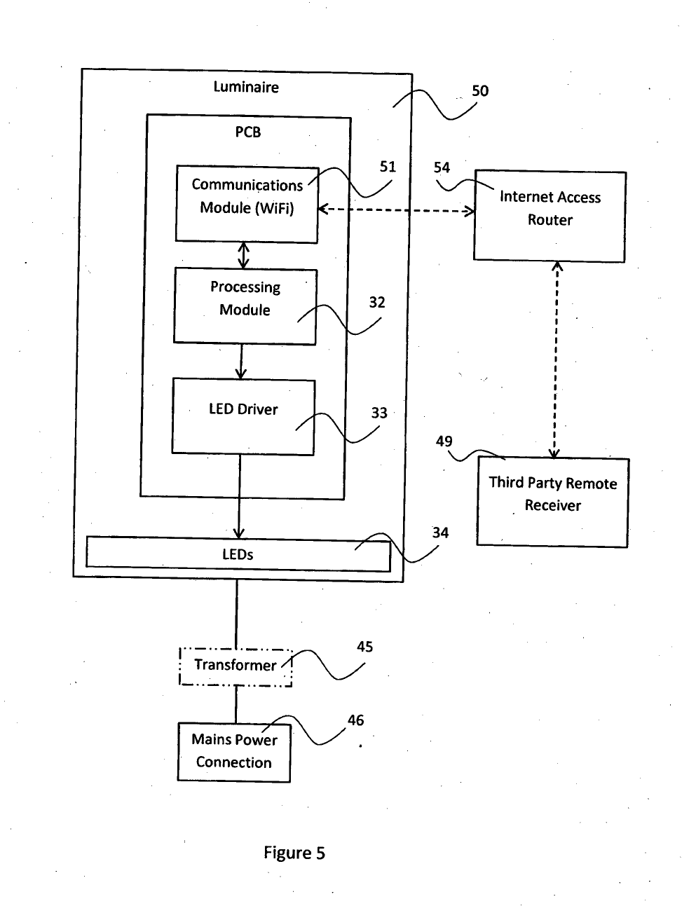

Referring to FIG. 5, we have a low energy consumption device, in this embodiment a luminaire 50 employing LED lighting elements 34. The LEDs are driven by LED driver 33, which may be controlled by Processing Module 32. Power is provided to the luminaire by Mains Power Connection 46, via optional transformer 45.

Processing Module 32 is in data communication with Communications Module 51, which is equipped for wi-fi communication.

The Communications Module 51 is in data communication via wi-fi with Internet Access Router 54. Internet Access Router 54 in turn provides communication, via the internet, with Third Party Remote Receiver 55.

In use, when the luminaire is installed in domestic or commercial premises, and electricity is provided to the luminaire, the Communications Module establishes wi-fi communication with Internet Access Router 54. In general this will be a router already provided on the premises or it may be a device provided for this purpose.

When communications is established, the Processing Module 32 employs the Communications Module 51 to communicate a verification code, indicating successful installation, via the Internet Access Router to the Third Party Remote Receiver 49. Upon receipt of an indication of successful installation, the third party may provide an agreed incentive.

In an alternative embodiment, Communications Module 51 communicates with a Local Receiver and Remote Communications. Module similar to that of the embodiment of FIG. 4, the Local Receiver and Remote Communications Module providing communication to the Internet Access Router 54. This enables the insertion of additional data, such as premises identity, into the data communicated to the Third Party Remote Receiver. It may also allow for a less sophisticated implementation of the wi-fi protocol to be used in the Communications Module 51. Since establishment of wi-fi communication between an in-situ router and the Communications Module may be difficult or require additional manual steps, the use of a Local Receiver and Remote Communications Module which is designed to make contact with a Communications Module may simplify this set-up.

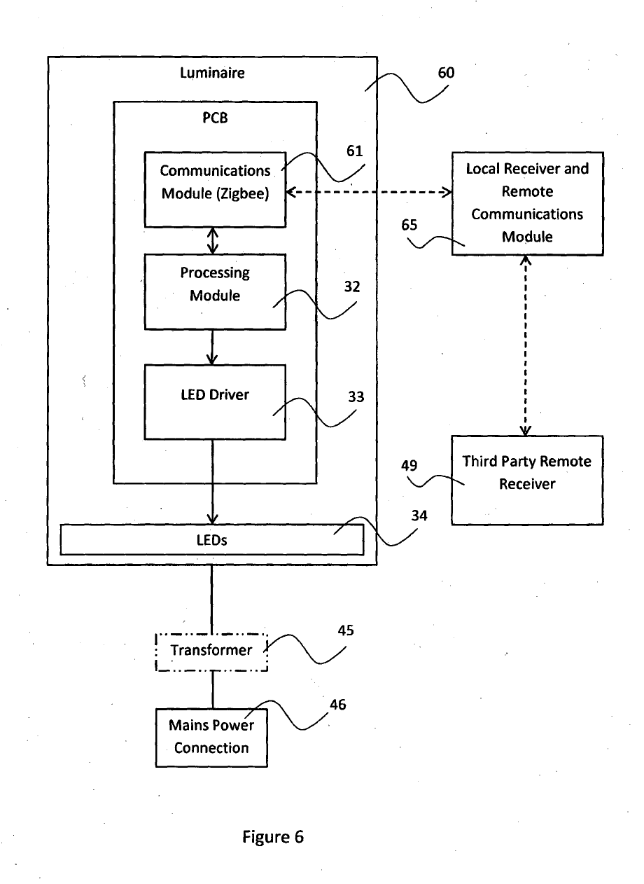

Referring to FIG. 6, there is provided a low energy consumption luminaire 60, employing LED lighting elements 34. There is a Communications Module 61 which is equipped for the Zigbee communications protocol. Zigbee is a low energy, short range communications protocol designed for communication between appliances.

The Communications Module 61 is in data communication with a Local Receiver and Remote Communications Module 65. The Local Receiver and Remote Communications Module allows communication with a Third Party Remote Receiver 49. The Local Receiver and Remote Communications Module may employ any suitable protocol for communication with the Third Party Remote Receiver. This may be, without limitation, a Zigbee mesh network, the public internet, power line communication, or the data services provided by mobile telephony networks.

In use, when the luminaire is installed in domestic or commercial premises, and electricity is provided to the luminaire, the Processing Module 32 employs the Communications Module 61 to communicate a verification code, indicating successful installation, via the Local Receiver and Remote Communications Module to the Third Party Remote Receiver 49. Upon receipt of an indication of successful installation, the third party may provide an agreed incentive.

In alternative embodiments, a control may be provided to cause the Processing Module to communicate the verification code, or the Communications Module may transmit the verification code at all times or at selected times, for example for a period following installation, or a period following each time the low energy consumption device is turned on.

In an alternative embodiment, the Communications Module transmits the verification control in response to a query from the Local Receiver and Remote Communications Module or the Third Party Remote Receiver. This communication may be a general poll message to all available devices or it may be a communication directed at the particular low energy consumption device.

The Local Receiver and Remote Communications module may be provided for the installation of the low energy consumption device or multiple devices within a premises. It may be provided as part of one low energy consumption device where a number are installed at a time.

In an embodiment, the Local Receiver and Remote Communications Module is a communications hub which provides general communication with an appliance network within a premises.

In further embodiments, the Local Receiver and Remote Communications Module may be contained in any appliance or other energy saving device installed in the premises having suitable communication and processing ability. This may be a Standby Power Controller (SPC) installed as a plug load controller for any other device(s), such as a PC or an audio visual installation, anywhere in the premises. In particular, the Local Receiver and Remote Communications Module may be provided as part of any of the energy monitoring devices disclosed in International Publication WO 2010/139020, which is hereby incorporated by reference.

In an embodiment, the Local Receiver and Remote Communications Module is provided as portable device carried by an installer. It may be a tablet or laptop computer running software which provides the function of the Local Receiver and Remote Communications module, the computer having appropriate communications hardware to allow it to communicate with the Communications Module and the Third Party Remote Receiver in any of the ways disclosed herein, or in any other appropriate way. Alternatively, the Local Receiver and Remote Communications module may be a stand-alone device having the Local Receiver and Remote Communications module functionality.

In such an embodiment, communication with the Third Party Remote Receiver may not be via the internet or any network. The Local Receiver and Remote Communications module may record the verification data for later direct or indirect download to the third party's systems for verification. Alternatively, the Local Receiver and Remote Communications module may perform the third party verification itself, having a list of valid verification codes loaded into it. In that case, only the fact that a verified installation has occurred is communicated to the third party. The third party then provides the agreed incentives.

In the described embodiments or in other embodiments, the Processing Module may further include functionality enabling the monitoring and recording of the operation of the LED luminaire. This usage data may then be communicated by the Communications Module directly or indirectly to the Third Party Remote Receiver.

The usage data will include information concerning the operating times of the luminaire. This may be actual on/off times, or cumulative hours of use. In alternative embodiments, circuitry for the determination of energy usage by the luminaire may be included, allowing the usage data to include the actual energy used by the luminaire.

The usage data may be communicated continuously or intermittently. The usage data may include data for all times or may include data for a sampling of times.

The usage data is communicated to the third party. Upon receipt of the usage data, the third party is able to calculate with significant accuracy, the actual energy use of the LED luminaire over time. This may be calculated by taking the known nominal energy consumption and combining with the usage data indicating the hours of use of the luminaire. Alternatively, the energy usage may be directly communicated in the usage data.

The third party is aware of the nominal energy usage of the lighting installation which was replaced by the low energy consumption LED luminaire, or which would have been installed as an alternative to the LED luminaire.

This information allows the energy saving made by installing the low energy consumption LED luminaire to be calculated.

The third party, having more accurate information about the energy actually saved by the low energy consumption device, is then able to make an incentive payment which is in proportion to the amount of energy actually saved by the installation, as well as, or instead of, an incentive based only upon the fact of the installation.

The proportional incentive may be paid for any period, from a once off payment after a period to prove the likely ongoing energy savings, or the incentive may be paid for the life of the installation.

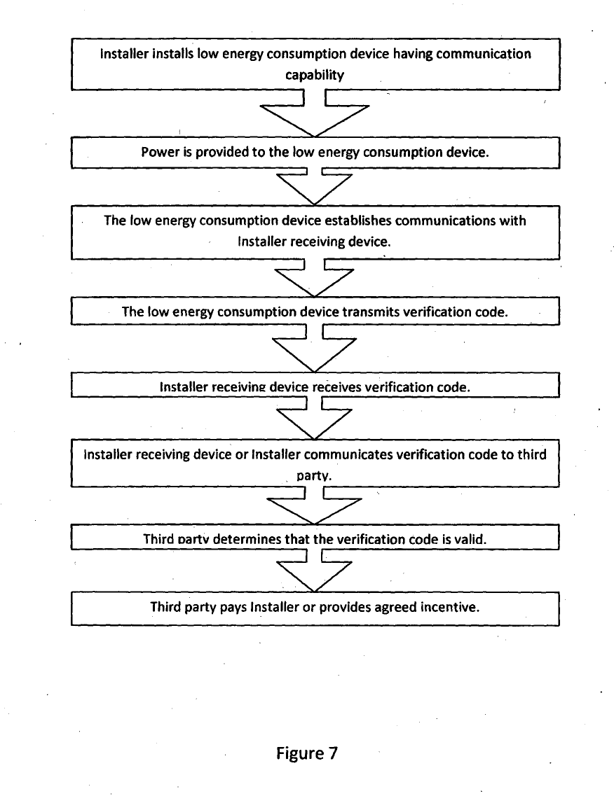

Referring now to FIG. 7, there is shown a flow chart of a method of verifying and incentivising the installation of a low energy consumption electrical device, where the installation is undertaken by a qualified installer.

The installer installs a low energy consumption device having communication capability in an end user's premises.

The installation may be being made at the cost of a third party, not the installer or the end user of the electrical devices.

In an exemplary case, the third party is an energy retailer wishing to reduce energy consumption by customers.

Upon installation, electrical power is provided to the low energy consumption device. The device employs the communication capability to establish communications with a receiving device carried by the installer. This may be a purpose built device, but in a preferred embodiment it will be a generic computing device such as a tablet or laptop computer or a smartphone. Any convenient communications protocol may be used, including without limitation, Zigbee, Wi-Fi and Bluetooth.

The low energy consumption device includes storage for a verification code. This is a code which identifies the low energy consumption device in a manner sufficient for the purpose of verifying installation. It may be unique to the low energy device, to a group of such devices, or to a class of such devices. The verification code may be a verification number or combination of letters or numbers, or any other suitable verification code.

Having established communication with the installer receiving device, the low energy consumption device transmits the verification code to the receiving device. In an alternative embodiment, the receiving device polls the low energy device, which does not transmit the verification code until the poll is received.

The installer's receiving device receives the verification code. The receiving device may provide an acknowledgement to the low energy consumption device indicating that the code has been received, and that further transmission of the code should not take place.

The verification code is conveyed to the third party, who may be an energy retailer, who is paying the cost of the installation of the low energy consumption device, or providing some incentive for the installation.

In a preferred embodiment, the energy retailer then takes the verification code and enters it into a database of previously provided verification numbers which are unique to each of the low energy consumption devices that the energy retailer has caused to be installed. Upon a successful match the energy retailer can then have a greater level of confidence that the installation of the low energy consumption device was carried out in the appropriate manner to ensure that, at least on initial installation, the low energy consumption device was brought into active use.

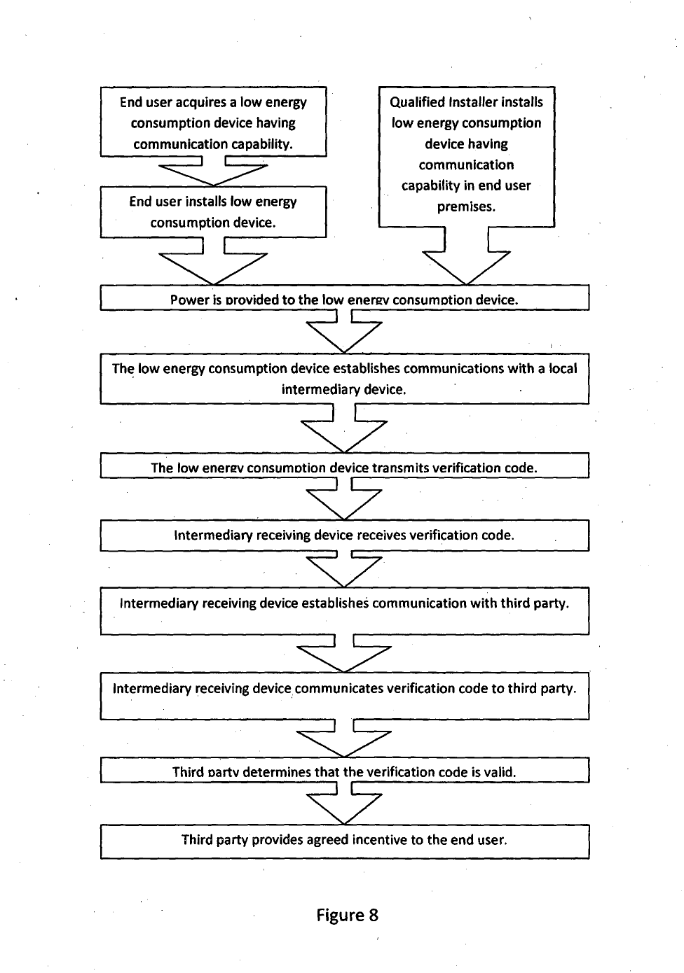

Referring now to FIG. 8, there is a flow chart of a method of verifying the installation of an electrical device in the case where the installation is undertaken by the end user. The end user may be a domestic householder or a commercial premises occupant. Alternatively, the installation may be undertaken by a qualified installer.

The end user acquires a low energy consumption device. This is a device which a third party, such as a government department or energy retailer or other energy market participant has determined to be of lower energy consumption than equivalent devices generally installed in end user premises. The third party wishes to encourage the installation of such low energy consumption devices. Accordingly, the third party is willing to offer incentives for such installation.

Incentives may include, without limitation, provision of the device at no or low cost, rebates or discounts on the end user's electricity bills, and loyalty program points. Any incentive likely to be attractive to an end user may be provided. In order to provide such incentives, the third party wishes to have a high degree of confidence that the low energy consumption device has actually been installed at end user premises.

The end user may acquire the device in any suitable way, including without limitation, by mail-out from the third party, from a door-to-door distributor, whether sent by the third party or otherwise, or by retail purchase.

The end-user self-installs the low energy consumption device, or arranges installation by an installer not related to the third party. In a preferred embodiment, the low energy consumption device is of a type which can be easily and legally installed by the end user, for example by plug connection to a light fixture or electrical outlet.

Alternatively, a qualified installer, whether acting for the third party, on their own account, or for the end-user, supplies and installs the low energy consumption device.

Upon installation, energy is provided to the low energy consumption device.

The low energy consumption device establishes communication with a local intermediary device. This local intermediary device may be a device provided for this function. More preferably it may be a device provided as part of the distribution of electricity to the premises, such as a Smartmeter. In a more preferred embodiment, the local intermediary device is a local appliance communication hub, providing communication and optionally control services for multiple appliances within the premises. The local intermediary device may also be a local data communication device providing external data communications for the premises, such as a wireless internet router.

The low energy consumption device includes storage for a verification code. This is a code which identifies the low energy consumption device in a manner sufficient for the purpose of verifying installation. It may be unique to the low energy device, to a group of such devices, or to a class of such devices. The verification code may be a verification number or combination of letters or numbers, or any other suitable verification code.

Having established communication with the local intermediary device, the low energy consumption device transmits the verification code to the receiving device. In an alternative embodiment, the intermediary device polls the low energy device, which does not transmit the verification code until the poll is received.

The local intermediary device receives the verification code. The local intermediary device may provide an acknowledgement to the low energy consumption device indicating that the code has been received, and that further transmission of the code should not take place.

The intermediary receiving device establishes contact with the receiving system provided by the third party or an agent of the third party to receive the verification information.

The verification code is transmitted to the third party system.

In an embodiment where the intermediary device is an internet router, the intermediary device will provide data transport, with the application level transactions being conducted between the low energy device and the third party receiving systems.

In an alternative embodiment the low energy consumption device is equipped with means to establish communications with the third party without the need for a local intermediary device, for example by the use of a mobile telephony network.

The verification code having been conveyed to the third party, the third party verifies that an installation has taken place by authenticating the verification code.

In a preferred embodiment, the third party is an energy retailer which then takes the verification code and enters it into a database of previously provided verification numbers which are unique to each of the low energy consumption devices that the energy retailer has caused to be installed. Upon a successful match the energy retailer can then have a greater level of confidence that the installation of the low energy consumption device was carried out in the appropriate manner to ensure that, at least on initial installation, the low energy consumption device was brought into active use.

Having determined that the verification code is valid, and thus having a high confidence that a low energy consumption device has been installed in end user premises, the third party provides the agreed incentive.

The agreed incentive may be provided to the end-user, or may be provided to the qualified installer. In the latter case, the cost to the end-user of the supply and installation of the low energy consumption device would be partly or wholly met by the qualified installer.

The method of the present invention now provides for a new way in which the installation of electronic devices, such as low energy consumption devices, can be verified as being installed currently. This provides the energy retailer and any other party, such as a Government body, a higher level of confidence in the successful installation of such devices than has been available previously.

Additionally, the present invention reduces or removes the requirement for additional audits or checks, thus saving substantial time and money to those that either distribute or financially support the distribution of such low energy consumption devices.

A further issue arises in that the third party provides incentives for the installation of low energy consumption devices based on the assumption that the devices will remain installed and continue to provide energy savings. Low energy device may, in some instances cause minor inconvenience when compared to higher energy consumption equivalents, which may be sufficient to motivate the user to uninstall the low energy consumption device.

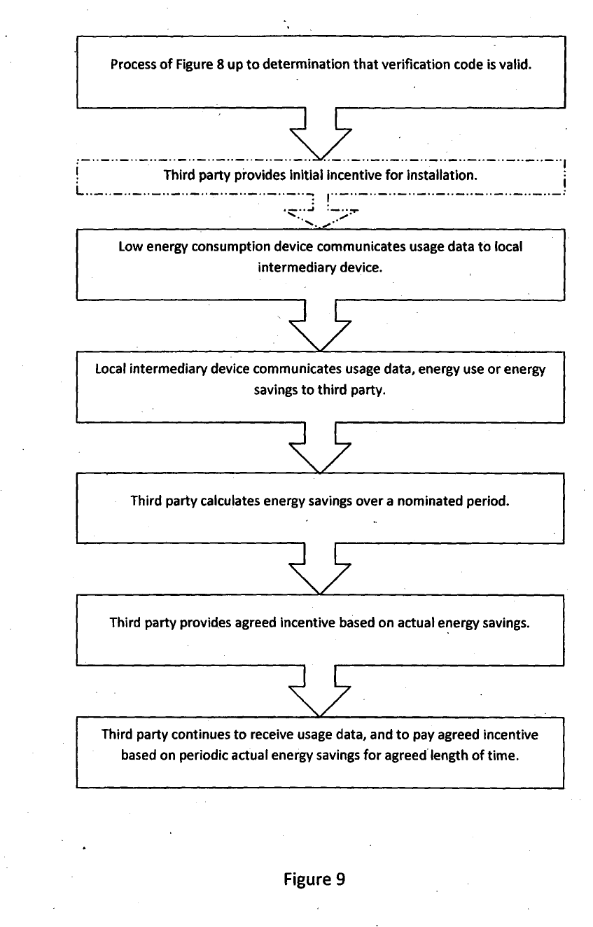

Referring now to FIG. 9, there is shown a flowchart of a system wherein the third party provides incentives in a staged manner in order to provide an ongoing incentive for an end user to keep the low energy consumption device installed.

The initial installation of the low energy consumption device, which may be one or more LED lighting luminaires, with communication capability is installed in any suitable manner, including those shown in FIG. 8. Verification of the installation of the device is provided to the third party, as described in FIG. 8. In an embodiment, the verification is by any means acceptable to the third party, which may or may not include the use of a verification code. In an embodiment, the third party will accept the establishment of communication with the low energy device as evidence of installation. This is more likely to be acceptable to the third party, because there is an ongoing communication and payment relationship between the installer and the third party, reducing the scope for fraud on the part of the installer.

The third party may provide an initial incentive for the installation. Where the incentive is provided directly to the end user, this incentive may be the provision of the low energy consumption device for no cost or at a reduced cost. Where the incentive is provided to a qualified installer, the incentive may take the form of a direct payment. The qualified installer may be employed by the third party.

The provision of an initial incentive payment is optional. The third party may provide a payment to fully or partly cover the cost of the supply and installation of the low energy consumption LED lighting. Alternatively, the end user or a qualified installer may completely or partly fund the supply and installation of the low energy consumption device in order to receive an ongoing incentive stream.

The end user then continues to use the low energy consumption device in the usual way for that device. Continuously, periodically or occasionally, the low energy consumption device communicates details of use to a local intermediary device. This may be in the form of raw usage data, simply hours of operation, or it may include actual energy consumption data, and/or calculated energy savings for the period concerned.

The usage data, if not communicated continuously, may be communicated periodically at any convenient period which may be a few seconds, to many days or weeks.

The local intermediary device communicates the usage data, energy use and/or energy savings to the third party. The Local Receiver and Remote Communications Module may calculate the energy savings from information about the low energy consumption device and the installation which was replaced in fitting the low energy consumption device and usage data provided from the low energy consumption device.

The third party, or the third party's systems, receives the data from the local intermediary device. This includes or permits the calculation of the energy savings made by the installation of the low energy consumption device over a nominated period.

The third party is now confident that the low energy consumption device is installed and continues to be in use, and has provided a certain energy saving. The third party now provides an agreed incentive, based on the actual energy savings achieved by the installation of the low energy consumption device.

This communication of usage data to the third party continues periodically for an agreed period, or indefinitely, with the third party continuing to provide an agreed incentive for the amount of energy saved by the installation of the low energy consumption device for that period.

In general, the incentive payment will vary by the amount of energy saving reported for a period, but it may also vary by the time since installation, by the cost of electricity for the period, or by any other agreed factors.

In an embodiment, the communication of the verification information, and the subsequent communication of usage information, are achieved without a local intermediary device. The low power consumption device may be equipped with a longer range communication capability, such as the data communication facility associated with a mobile telephony network.

In an embodiment, only the verification code may need to be communicated periodically to the third party verify that the low energy consumption device is still in use and to ensure that the user continues to receive the incentives. Since the verification code is held as data, the code may be changed periodically, and the third party may be require that this new code is received to ensure that the user continues to receive the incentives. The change in the verification code may be done by including an absolute time or time since installation component in the verification code, or by any other suitable means.

The changed verification code may indicate that a certain level of energy saving has been reached by the installation. This may be by pre-arrangement, or by encoding the energy savings achieved by the installation into the verification code. The energy savings may be calculated from the time during which the installation has been active, in the case of low energy consumption devices. In this case the energy saved is calculable as the difference in energy consumption between the low energy consumption device and the installation which it replaced, multiplied by the time for which the low energy consumption device has been active.

The embodiments disclosed herein have considered the verification of the installation of low energy consumption luminaires. The use of the invention is not so limited. The installation of other low energy consumption electrical devices may be verified by the methods and apparatus disclosed herein. Other low energy consumption electrical devices the installation of which a third party may wish to verify include low energy consumption pool pumps and air conditioning units. The apparatus and methods disclosed may be used to verify the installation of any electrical device where a third party, not being the installer or the user, wishes to verify an installation. This may include, without limitation, installation of energy saving devices such as standby power controllers (SPCs) or swimming pool pump controllers. All references to low energy consumption devices herein are to be taken to also be references to energy saving devices.

Although the invention has been herein shown and described in what is conceived to be the most practical and preferred embodiments, it is recognized that departures can be made within the scope of the invention, and that various modifications may be made in details of design and construction [and process steps, parameters of operation etc without departing from the scope and ambit of the invention.

1. An electrical device adapted to:
a. be installed by connection at an installation premises to a mains electricity supply, and
b. upon installation of the electrical device at the installation premises, communicate to a monitoring entity located remotely from the installation premises.

2. The electrical device of claim 1 wherein the communication to the monitoring entity upon installation includes information:
a. sufficient to validate that a successful installation has taken place, and
b. including identification information which the monitoring entity compares to pre-existing information held by the monitoring entity.

3. The electrical device of claim 2 wherein the information sufficient to validate that a successful installation has taken place includes a verification code.

4. The electrical device of claim 3 wherein the verification code is unique to the particular electrical device being installed.

5. The electrical device of claim 1 further adapted to be plug connected to the mains electricity supply.

6. The electrical device of claim 1 wherein the electrical device is further adapted to be plug connected to a fixture adapted to provide electrical energy suitable for the electrical device.

7. The electrical device of claim 1 wherein the electrical device is a low energy consumption device.

8. The electrical device of claim 1 wherein the electrical device is a luminaire.

9. The electrical device of claim 8 wherein the luminaire is an LED luminaire.

10. The electrical device of claim 8 wherein the luminaire is a compact fluorescent light luminaire.

11. The electrical device of claim 1 wherein the electrical device includes a wireless transmitter effecting the communication to the monitoring entity.

12. The electrical device of claim 1 wherein the electrical device includes one or more of:
a. a WI-Fi communication transmitter;
b. Zigbee communication transmitter; and
c. a power line communication module configured to transmit communications over a power line.

13. The electrical device of claim 1 further adapted to communicate information concerning the ongoing use of the electrical device to the monitoring entity.

14. A method for verifying the installation of an electrical device at an installation premises by which a third party:
i. located remotely from the installation premises, and
ii. not being an installer or an end user of the electrical device, may have a higher degree of confidence that said installation has occurred,
wherein the electrical device, upon installation at the installation premises, communicates verifying information to the third party, the verifying information being sufficient to verify that the installation has occurred.

15. The method of claim 14 wherein the third party determines that the verifying information is sufficient to verify that the electrical device has been installed.

16. The method of claim 15 wherein the third party, upon determining that the verifying information is sufficient to verify that the electrical device has been installed, provides a valuable consideration to the end user of the electrical device as an incentive for installing the electrical device.

17. The method of claim 15 or claim 16 wherein the electrical device is a luminaire.

18. A method for verifying the installation of an electrical device at an installation premises, wherein a third party which is:
i. not an installer or an end user of the electrical device, and
ii. located remotely from the installation premises,
may have a higher degree of confidence that said installation has occurred, wherein the electrical device, upon installation at the installation premises,
a. establishes communications with a local intermediary device,
b. transmits a verification code able to identify the electrical device to the local intermediary device,
with the local intermediary device communicating the verification code to the third party.

19. The method of claim 18 wherein the third party:
a. determines that the verification code is valid and,
b. upon determining that the verification code is valid, provides a valuable consideration to the end user of the electrical device as an incentive for installing the electrical device.

20. The method of claim 18 or claim 19 wherein the low energy consumption device is the device of any one of claims 1-12.

21. A method for providing an incentive for the installation and use of a low energy consumption electrical device at an installation premises, the method including the steps of:
the electrical device, upon installation at the installation premises, communicating verifying information to a third party which is not an installer or an end user of the electrical device, the verifying information being sufficient to verify that the installation has occurred;
the third party determining that the verifying information is sufficient to verify that the electrical device has been installed;
the electrical device communicating usage information to the third party, the usage information being dependent on the usage of the electrical device;
the third party using the usage information to determine a degree to which the installation and usage of the electrical device is contributing to reduced energy consumption;
the third party providing a valuable consideration to the end user of the electrical device.

22. The electrical device of claim 1 in combination with a remote communications module:
a. separate from, and adapted to communicate with, the electrical device; and
b. separate from, and adapted to communicate with, the monitoring entity.

23. The electrical device of claim 1 wherein the electrical device is adapted to communicate wirelessly with an internet-connected router, the router providing communication to the monitoring entity.

24. The method of claim 14 wherein the third party is an energy utility.

25. The method of claim 14 wherein the third party is a government agency.
